(19) United States
(12) Patent Application Publication
(10) Pub. No.: US 2024/0291785 A1
(43) Pub. Date: Aug. 29, 2024

(54) SCRAPING EMAILS TO DETERMINE PATENTABLE IDEAS

(71) Applicant: STATE FARM MUTUAL AUTOMOBILE INSURANCE COMPANY, Bloomington, IL (US)

(72) Inventors: Brian Mark Fields, Phoenix, AZ (US); Nathan L. Tofte, Downs, IL (US); Joseph Robert Brannan, Bloomington, IL (US); Vicki King, Bloomington, IL (US); Justin Davis, Bloomington, IL (US)

(21) Appl. No.: 18/443,614

(22) Filed: Feb. 16, 2024

Related U.S. Application Data
(60) Provisional application No. 63/456,254, filed on Mar. 31, 2023.
(60) Provisional application No. 63/486,829, filed on Feb. 24, 2023.

(51) Int. Cl. H04L 51/21; G06F 40/40

(52) U.S. Cl. CPC H04L 51/21; G06F 40/40

(57) ABSTRACT

The following relates generally to using artificial intelligence (AI) and/or machine learning (ML) to identify patentable ideas from company emails. In some embodiments, one or more processors: access one or more email messages; identify, via a machine learning (ML) chatbot trained to analyze text and generate text, one or more patentable concepts in the one or more email messages; compare the one or more patentable concepts to a patent database including published patent applications with respective publication dates on or before the date of database access, wherein comparing includes generating a comparison document indicating at least one difference and/or at least one similarity between the one or more patentable concepts and the patent applications of the patent database, wherein the comparing includes using the ML chatbot; and generate, based upon the comparison, one or more novelty scores for each of the one or more patentable concepts.

### CROSS REFERENCE TO RELATED APPLICATIONS

This application claims the benefit of U.S. Provisional Application No. 63/486,829, entitled “Scraping Emails to Determine Patentable Ideas” (filed Feb. 24, 2023); and U.S. Provisional Application No. 63/456,254, entitled “Scraping Emails to Determine Patentable Ideas” (filed Mar. 31, 2023), the entirety of each of which is incorporated by reference herein.

### FIELD OF THE INVENTION

The present disclosure generally relates to using artificial intelligence (AI) and/or machine learning (ML) to (i) identify patentable ideas from company emails; (ii) scrape emails to determine questions associated with a scheduled meeting; (iii) scrape emails to determine connections between company employees, ideas, teams, or projects; (iv) scrape emails to assess employee satisfaction; and/or (v) analyze incoming emails and generate automatic responses.

### BACKGROUND

One of the biggest challenges in finding patentable ideas may be identifying whether an idea has already been patented or published. With the vast amount of information available on the internet, it may be difficult to determine whether an idea is truly novel. Additional challenges exist in fields such as software and business methods, where the criteria for what can be patented have become increasingly stringent.

Another often dismissed challenge may be in identifying novel ideas as patentable material. For example, engineers at an enterprise may exchange emails about an issue and suggest possible solutions. Among these suggested solutions, some may be novel ideas worth developing into a patent application. However, engineers may not always identify these ideas as novel or patentable, especially if those ideas never become implemented as solutions. Conventional techniques may have other encumbrances, ineffectiveness, inefficiencies, or drawbacks as well.

### SUMMARY

The present embodiments may relate to, inter alia, systems and methods for scraping emails and performing language generative functions using information scraped from the emails using a machine learning (ML) and/or artificial intelligence (AI) chatbot. In general, in some embodiments, the computer systems described herein may include one or more local or remote processors, servers, sensors, mobile devices, transceivers, memory units, chatbots, voice bots, ChatGPT bots, smart glasses or contacts, augmented reality glasses, virtual reality headsets, mixed or extended reality headsets, and other electronic or electronic components, which may be in wired or wireless communication with one another.

In one aspect, a computer system for analyzing emails to determine patentable concepts may be configured to (1) access one or more email messages; (2) identify, via a machine learning (ML) chatbot (or voice bot) trained to analyze text and generate text, one or more patentable concepts in the one or more email messages; (3) compare the one or more patentable concepts to a patent database including published patent applications with respective publication dates on or before the date of database access, wherein comparing includes generating a comparison document indicating at least one difference and/or at least one similarity between the one or more patentable concepts and the patent applications of the patent database, wherein the comparing includes using the ML chatbot; and/or (4) generate, based upon the comparison, one or more novelty scores for each of the one or more patentable concepts. The computer system may include additional, less, or alternate functionality, including that discussed elsewhere herein.

In another aspect, the computer system is further configured to (1) identify, via the ML chatbot, from the accessed one or more email messages, one or more potential questions associated with a scheduled meeting; (2) to identify, via the ML chatbot, percentage of the scheduled meeting attendees associated with the each one or more potential questions; (3) to determine, via the ML chatbot, probability of the each one or more potential questions being asked; (4) to generate, via the ML chatbot, suggested answers to the each one or more potential questions; and/or (5) to send, via the ML chatbot, the list of identified one or more potential questions and their suggested answers to a meeting organizer. The computer system may include additional, less, or alternate functionality, including that discussed elsewhere herein.

In another aspect, the computer system is further configured to (1) receive, at the ML chatbot, a list of employees associated with one or more projects; (2) analyze, via the ML chatbot, the accessed one or more email messages, and label email messages associated with the one or more projects; (3) identify, via the ML chatbot, email message authors of the labeled email messages; (4) identify, via the ML chatbot, select labeled email messages, associated with projects which authors are not associated with the projects; and/or (5) generate, via the ML chatbot, an email message to the select labeled email messages authors, inviting the select labeled email messages authors to connect with the employees associate with the project. The computer system may include additional, less, or alternate functionality, including that discussed elsewhere herein.

In yet another aspect, the computer system is further configured to analyze, via the ML chatbot, the accessed one or more email messages to determine an employee satisfaction score.

In yet another aspect, the computer system is further configured to (1) analyze, via the ML chatbot, contents of a received email message from the accessed one or more email messages; (2) determine, via the ML chatbot, a tone of the analyzed received email message; and/or (3) generate, via the ML chatbot, one or more responses to the analyzed received email message, at least one of the responses using the determined tone of the analyzed received email message.

In another aspect, a computer-implemented method for analyzing emails to determine patentable concepts, is implemented. The method may include (1) accessing one or more email messages; (2) identifying, with a machine learning (ML) chatbot trained to analyze text and generate text, one or more patentable concepts in the one or more email messages; (3) comparing the one or more patentable concepts to a patent database including published patent applications with respective publication dates on or before the date of database access, wherein the comparing includes generating a comparison document indicating at least one difference and/or at least one similarity between the one or more patentable concepts and the patent applications of the patent database, and wherein the comparing includes using the ML chatbot; and/or (4) generating, based upon the comparison, one or more novelty scores for each of the one or more patentable concepts. The method may include additional, less, or alternate actions, including that discussed elsewhere herein.

In another aspect, the computer-implemented method further may include (1) identifying, via the ML chatbot, from the accessed one or more email messages, one or more potential questions associated with a scheduled meeting; (2) identifying, via the ML chatbot, percentage of the scheduled meeting attendees associated with the each one or more potential questions; (3) determining, via the ML chatbot, probability of the each one or more potential questions being asked; (4) generating, via the ML chatbot suggested answers to the each one or more potential questions; and/or (5) sending, via the ML chatbot, the list of identified one or more potential questions and their suggested answers to a meeting organizer. The method may include additional, less, or alternate actions, including those discussed elsewhere herein.

In another aspect, the computer-implemented method further may include (1) receiving, at the ML chatbot, a list of employees associated with one or more projects; (2) analyzing, via the ML chatbot, the accessed one or more email messages, and label email messages associated with the one or more projects; (3) identifying, via the ML chatbot, email message authors of the labeled email messages; (4) identifying, via the ML chatbot, select labeled email messages, associated with projects which authors are not associated with the projects; and/or (5) generating, via the ML chatbot, an email message to the select labeled email messages authors, inviting the select labeled email messages authors to connect with the employees associate with the project. The method may include additional, less, or alternate actions, including those discussed elsewhere herein.

In another aspect, the computer-implemented method further comprises analyzing, via the ML chatbot, the accessed one or more email messages to determine an employee satisfaction score.

In yet another aspect, the computer-implemented method further may include (1) analyzing, via the ML chatbot, contents of a received email message from the accessed one or more email messages; (2) determining, via the ML chatbot, a tone of the analyzed received email message; and/or (3) generating, via the ML chatbot, one or more responses to the analyzed received email message, at least one of the responses using the determined tone of the analyzed received email message. The method may include additional, less, or alternate actions, including those discussed elsewhere herein.

### BRIEF DESCRIPTION OF THE DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The figures described below depict various aspects of the applications, methods, and systems disclosed herein. Each figure depicts an embodiment of a particular aspect of the disclosed applications, systems and methods, and that each of the figures is intended to accord with a possible embodiment thereof. Furthermore, wherever possible, the following description refers to the reference numerals included in the following figures, in which features depicted in multiple figures are designated with consistent reference numerals.

FIG. 1 illustrates an exemplary computing environment for scraping emails and performing language generative functions using scraped information utilizing a machine learning (ML) and/or artificial intelligence (AI) chatbot, according to one embodiment.

FIG. 2 illustrates an exemplary computer-implemented method of leveraging a chatbot to identify patentable ideas from company emails.

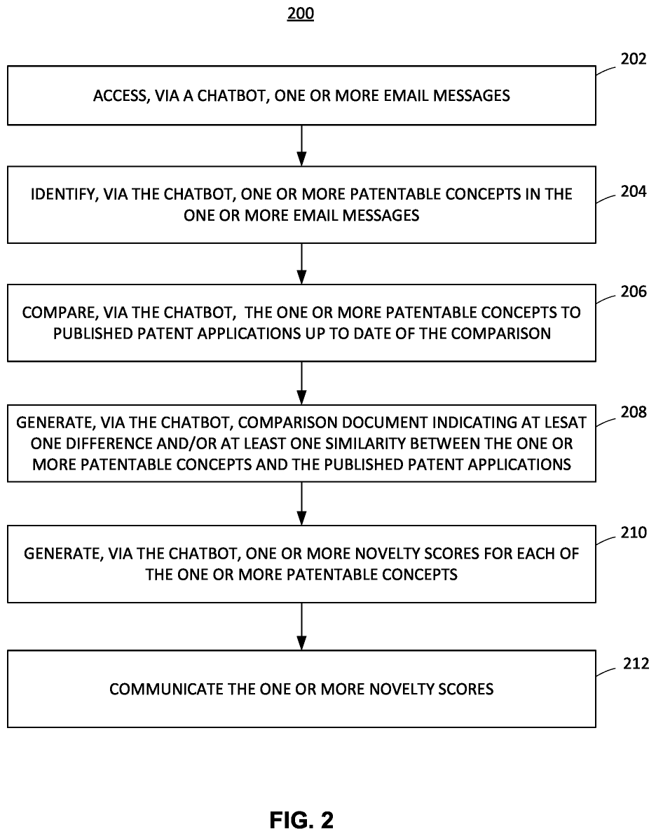

FIG. 3 illustrates an exemplary computer-implemented method of leveraging a chatbot to scrape emails to determine questions associated with a scheduled meeting.

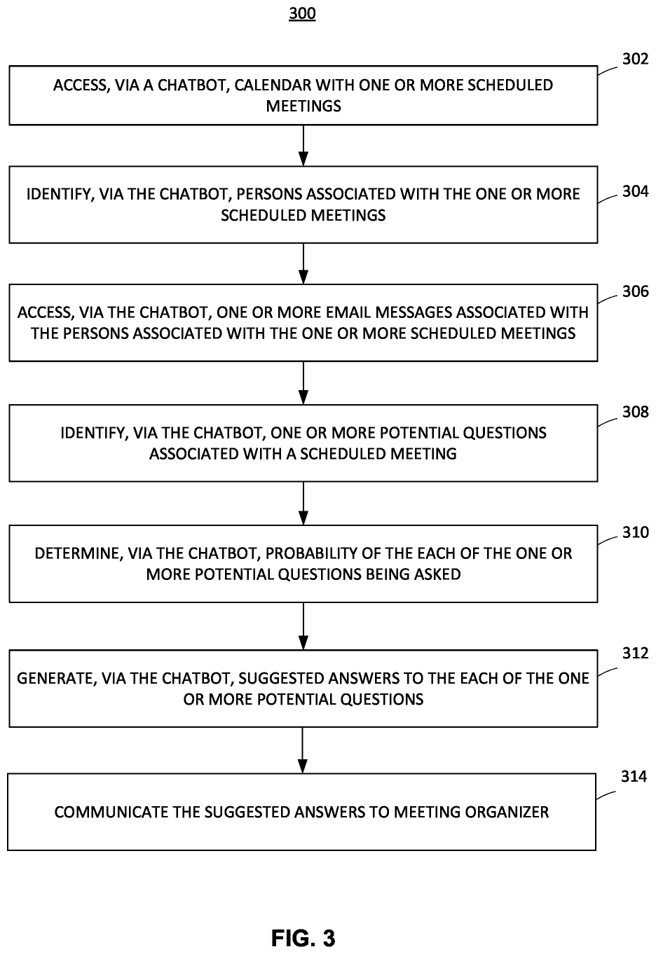

FIG. 4 illustrates an exemplary computer-implemented method of leveraging a chatbot to analyze company emails to determine connections between company employees, ideas, teams, and/or projects.

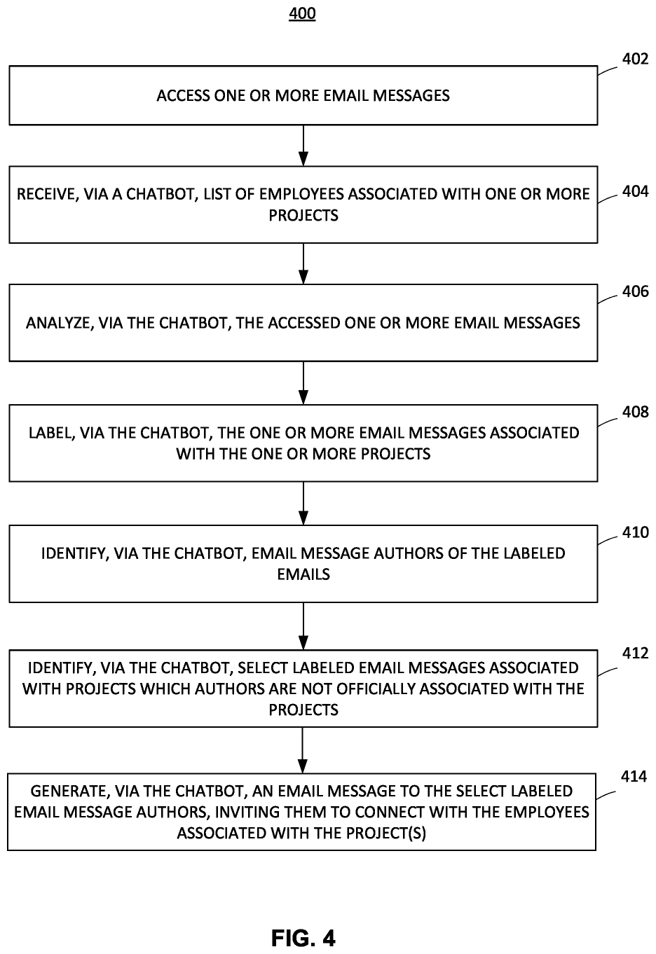

FIG. 5 illustrates an exemplary computer-implemented method of leveraging a chatbot to scrape emails to assess employee satisfaction.

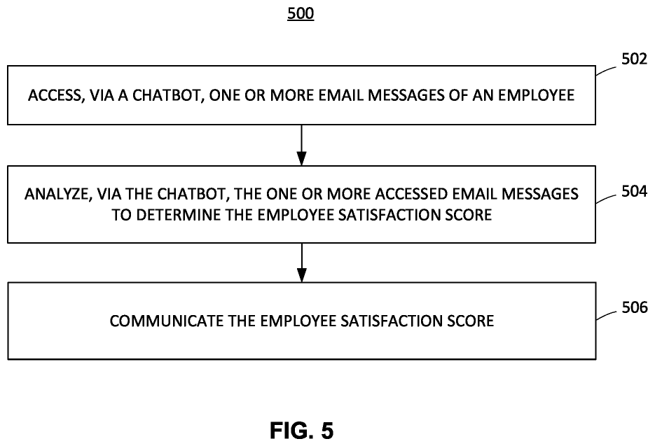

FIG. 6 illustrates an exemplary computer-implemented method of leveraging a chatbot to analyze received emails and generate automatic responses.

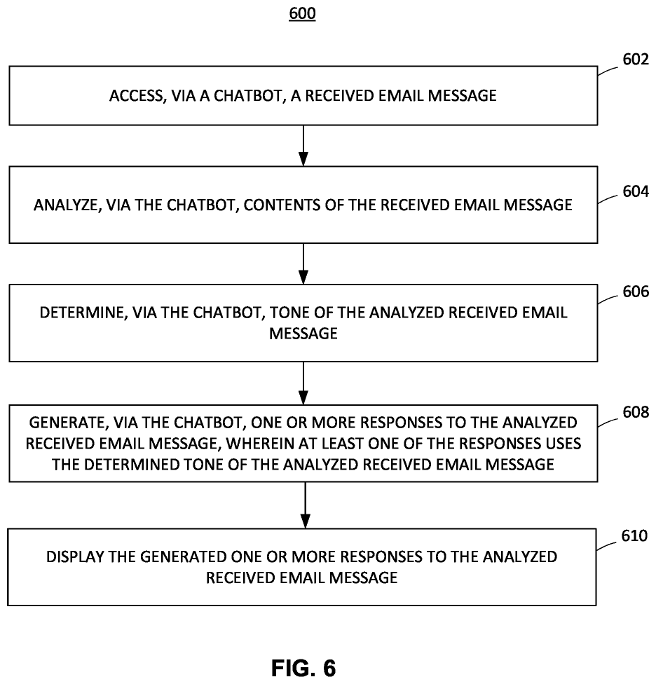

The figures depict preferred aspects for purposes of illustration only. One skilled in the art will readily recognize from the following discussion that alternative aspects of the systems and methods illustrated herein may be employed without departing from the principles of the invention described herein.

### DETAILED DESCRIPTION

Artificial intelligence (AI) and machine learning (ML) chatbots may be flexible and adaptable tools that may be applied to a wide range of applications. Such chatbots may often be described as a language model, capable of generating human-like responses for a given prompt, the responses based upon trained transformative analysis of large dataset of text.

Traditionally, chatbots have been used to chat with users, but their capabilities have expanded significantly with recent developments in the technology. Present day chatbots can perform many tasks, such as retrieving information, comparing information or data, finding patterns in information, generating reports based upon provided information, automating routine tasks, answering questions, answering emails, making recommendations, and much more.

In addition to text generating interfaces, chatbots can integrate voice assistants and other platforms, allowing them to interact with users through a variety of channels. Chatbots may even incorporate natural language processing (NLP) and machine learning (ML) technologies to understand and respond to user input in more sophisticated ways.

As a language model, models such as, for example, ChatGPT can assist with analyzing company emails in a number of different ways. For example, an AI or ML chatbot can be used to identify topics and themes of emails. Employees may be asked for consent to access and analyze their emails and further to share or distribute the information retrieved or generated from the emails.

More specifically, a user may task an AI chatbot with identifying novel or patentable ideas or concepts in emails. For example, the AI chatbot can access and scrape enterprise emails for ideas, specifically to identify novel ideas that can be patented. In aspects, the AI chatbot may scrape emails for any ideas on any topics. Alternatively or additionally, the AI chatbot may scrape emails for patentable ideas related to specific topics, such as topics determined by a user or predetermined by instructions. The topics, for example, may be related to a project (e.g., a project an engineer or a team is working on), or a technical area (e.g., software, mechanical, chemical, etc.). In some aspects, all enterprise emails may be analyzed or emails associated with a certain group, team, or a project or emails of a specific person or persons. The AI chatbot may operate with full or partial consent to access and analyze employee emails, for example it may access only emails sent to and/or received from designated person(s) and/or team(s).

The AI chatbot may compare these identified novel ideas to the content of data repositories such as patent databases including published issued patents and published patent applications, or published articles, for example online scientific manuscripts, or articles published in any publicly accessible media channels, etc. The AI chatbot may also compare the identified novel ideas to any publicly accessible online content, such as product listings, advertisements, blog posts, etc. The comparison may include generating a comparison document indicating at least one difference and/or at least one similarity between the one or more identified novel ideas and the contents of the searched data repositories. The AI chatbot may utilize NLP to identify the similarities or differences.

The user may further task the AI chatbot with estimating novelty of each of the identified patentable ideas or concepts and provide a novelty score or confidence of novelty. For example, the novelty score can be a number on a scale from 0 to 10 or from 0 to 100, where the score of 0 corresponds to an idea that has already been disclosed, and the highest score on the scale corresponds to an idea that has not been previously disclosed in any of the searched databases or online data repositories. As another example, a confidence of novelty may be expressed as a percentage of confidence, such as confidence percentage value between 0 and 100%. The novelty score or confidence may be calculated based upon similarity or difference of the identified novel idea from the analyzed published ideas. In aspects, the user may ask the AI chatbot to recommend modifications to the identified novel ideas that would increase their novelty score.

In certain aspects, the AI chatbot may be programmed to perform the above described tasks or steps on a script or may require user input to initiate, define, specify, or customize each step of the method. In some aspects, the described steps may be performed periodically, for example at scheduled times or with predetermined time intervals, such as once a week or once a month, or following known scheduled events, such as after a set time period following a conference or a meeting (for example, after one week following each team meeting). The scheduled periodic email scraping may analyze new emails since the previously scheduled analysis and/or may analyze new emails in consideration of or in combination with the previously analyzed emails.

In some aspects, the AI chatbot may continuously analyze emails and periodically present a user or users with a list of patentable ideas scraped from the emails. The user or users may be the associated authors of the analyzed emails or the associated authors of the identified ideas, or members of the company intellectual property department. In some aspects, a threshold may be set on the novelty score, and the system may alert a user of users of the novel ideas with a novelty score above the set threshold.

In certain aspects, an AI or ML chatbot or voice bot may interview employee(s) and suggest patentable ideas based upon the interview. The suggestions may be offered in real time or after the interview based upon analysis of the interview transcript.

In some aspects, emails can be scraped to determine questions that will be raised at a meeting. Prior to a meeting, an AI or ML chatbot may access emails of meeting attendees, analyze emails, identify potential or probable questions, and send a list of the probable questions to a meeting organizer. In some aspects, an AI or ML chatbot may determine what percentage of people are associated with each of the identified questions and/or may determine a probability of each question being asked. AI may provide suggested answers to the identified questions. The AI chatbot may determine if there are discrepancies in viewpoints on a particular topic (e.g., a situation where first person says project is one week behind, second person says it's two weeks behind, third person says it's three weeks behind, etc.).

In certain aspects, an AI or ML chatbot may scrape or analyze emails to determine connections, such as connections between company employees, ideas, teams, or projects. In a company, sometimes different, disconnected groups are working on similar projects, but neither group is aware of the other's project. AI may be used to scrape emails and recommend connections/collaborations between people or teams. AI may also provide a suggested introductory email for one person in a group to send to a person in another group.

In another example (applicable inside or outside of a work environment), the AI may recommend that a person join a particular group, project, or activity. For instance, the AI may recommend that a student join a particular afterschool group. In some aspects, an AI or ML chatbot may scrape or analyze emails to determine employee satisfaction. AI may scape emails to determine employee satisfaction with a particular project or at work generally. For example, an AI chatbot may be used to analyze the sentiment of emails, such as determine whether an email is positive, negative, or neutral in tone, or even happy, angry, frustrated, etc. This may be useful in identifying potential issues or problems within a company, tracking employee morale, identifying trends and patterns within a company, as well as understanding what employees are discussing most frequently. The AI chatbot may use any obtained, accessed, or analyzed data, including tone from emails, or use video data (e.g., facial expression of employee often showing frustration).

In some aspects, the AI may need to be trained on previously collected email or video data. There may be a privacy layer to protect employees. The AI chatbot may also determine a team's overall satisfaction with a project (e.g., percentage of employees happy with the project, or percentage of employees feeling a certain sentiment towards the project, etc.). In some aspects, the AI chatbot may also analyze employee emails for suggestions on how to improve the employee or the team's satisfaction of a project or generate such suggestions based upon other data.

In some aspects, an AI or ML chatbot may provide automatic or semiautomatic answers to an email or suggestions for answers to an email. AI may read or analyze an incoming email and provide suggested response email. The suggested response email may be “authentic” in that it mimics a tone or writing style of the person who will send it. It may also consider a tone (e.g., happy, angry, frustrated, excited, etc.) of the incoming email and respond appropriately, for example, mimicking the tone, or placating the tone, or disregarding the tone of the incoming email, or respond in a neutral tone.

In certain aspects, a default responding tone may be predetermined by a user. The AI chatbot may present different versions of a response email to the user, and the user may further choose or instruct the AI chatbot to select one of the presented response email versions. The AI chatbot may be further trained on the particular user selections to improve the future suggested responses for the particular user. The AI email response generator may be trained on specific topics, such as insurance, finance, medical, education, research topics, technical topics, or any other specialized field topics.

### Exemplary Computing Environments

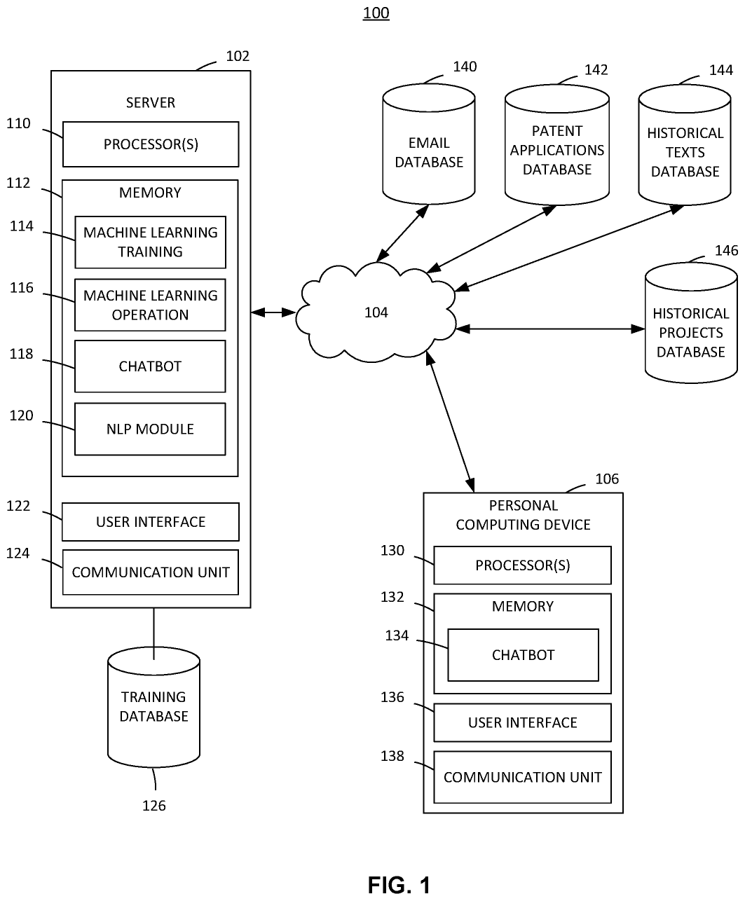

Turning to the figures, FIG. 1 illustrates a block diagram of an exemplary computing environment 100 for utilizing a machine learning (ML) and/or artificial intelligence (AI) chatbot for scraping emails and performing language generative functions using scraped information, in accordance with aspects of the systems, methods and techniques of the present disclosure. The various components of the computing environment 100 are communicatively connected and operate to implement the methods described further herein.

The high-level architecture illustrated in FIG. 1 may include both hardware and software applications, as well as various data communications channels for communicating data between the various hardware and software components, as described below. The computing environment 100 may include one or more servers, such as a server 102. The server 102 is configured to communicate, e.g., via a network 104 (which may be a wired and/or wireless network), with a personal computing device 106 and data repository databases such as an email database 140, a patent applications database 142, a historical texts database 144, and a historical projects database 146. The one or more networks 104 may be a single communication and/or data network or may include multiple communication and/or data networks (e.g., one or more wired and/or wireless local area networks (LANs), one or more wired and/or wireless wide area networks (WANs), which may include the Internet), one or more public and/or private networks and/or one or more other types of networks (e.g., one or more mesh networks).

The server 102 may include one or more processors 110, one or more tangible, non-transitory memories, memory storage devices or data storage units 112, a user interface 122 and a communication unit 124. Each of the one or more processors 110 may be a programmable microprocessor that executes computer-executable instructions stored in the one or more memories 112 to execute some or all of the functions of the server 102. Processor(s) 110 may include one or more central processing units (CPUs) and/or one or more graphics processing units (GPUs), for example. Alternatively, or in addition, some of the processors 110 may be other types of processors (e.g., application-specific integrated circuits (ASICs), field-programmable gate arrays (FPGAs), etc.). In an aspect, the computing environment 100 may include one or more servers 102 that may be a local computing system or a part of a local computing system. In other aspects, the server 102 may be implemented as a bank of servers, a virtual private network of computing devices, a cloud computing system, or any other suitable implementation. In yet another aspect, some of the functionality of the computing system may instead be implemented in hardware.

The one or more memories 112 of the server 102 may include one or more tangible, non-transitory memory storage devices or components. In an example aspect, the memory 112 may store thereon one or more artificial intelligence (AI) or machine learning (ML) training applications or modules 114, one or more ML operation applications or modules 116, one or more voicebots or chatbots 118, and one or more natural language processing (NLP) modules 120. Although the following discussion refers to an ML algorithm, it should be appreciated that it applies equally to ML algorithms and/or AI algorithms. In some aspects, the memory 112 comprises a set of computer-executable instructions stored on the ML training module 114 that are executable by the one or more processors 110 to generate, train, and/or update one or more ML models such as the one or more models stored on the chatbot 118 and/or the NLP module 120.

In general, a computer program or computer based product, application, or code (e.g., the model(s), such as ML models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor(s) 110 (e.g., working in connection with the respective operating system in memory 112) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C #, Objective-C, Java, Scala, ActionScript, JavaScript, HTML, CSS, XML, etc.).

The ML operation module 116 may comprise a set of computer-executable instructions implementing ML loading, configuration, initialization and/or operation functionality. The ML operation module 116 may include instructions for storing trained models (e.g., the chatbot 118 and/or the NLP module 120). Once trained, the one or more trained ML models may be operated in inference mode, whereupon when provided with a new input that the model has not previously been provided, the model may output one or more predictions, classifications, etc., as described herein.

The user interface 122 can include one or more input devices configured to receive user commands, such as a touchscreen, a keyboard, a microphone, a joystick, a camera, etc. and one or more output devices configured to provide visual, audio and/or tactile output, such as a projector, a screen, a touchscreen, or a speaker. The communication unit 124 can include one or more communication interfaces such as hardware, software and/or firmware for enabling communications via a cellular network, a WiFi network, or any other suitable network such as the network 104.

The email database 140 may hold any information, such as emails, text messages, instant messages, internal communication network messages, digitized notes, etc. In some aspects, the email database 140 is owned by a company that provides emails to companies, and/or provides text messaging services to companies. The email database 140 may be a relational database, such as Oracle, DB2, MySQL, a NoSQL based database, such as MongoDB, or another suitable database.

The patent applications database 142 may hold any information, such as published utility and/or design patents, published and/or unpublished utility and/or design patent applications. In some aspects, the patent applications database 142 may be an online public access database (e.g., a Google Patents database). In other aspects, the patent applications database 142 may hold company's internal intellectual property assets, such as filed or in progress patent applications. In yet other aspects, the patent applications database 142 may hold published articles, for example online scientific manuscripts, or articles published in any publicly accessible media channels, product listings, advertisements, blog posts, etc. The patent applications database 142 may be a relational database, such as Oracle, DB2, MySQL, a NoSQL based database, such as MongoDB, or another suitable database.

The historical texts database 144 may hold any information, such as essays, letters, emails, stories, novels, messages, text messages, opinions, articles, blogs, social media posts, etc. The historical texts database 144 may be a library database, a private or a public access database, or an online source. The historical texts database 144 may be a relational database, such as Oracle, DB2, MySQL, a NoSQL based database, such as MongoDB, or another suitable database.

The historical projects database 146 may hold any information, such as officially identified company's current projects, completed projects, proposed projects, hypothetical projects, suggested projects, current and/or past projects at same or related industry companies, projects scraped from the internet, etc. The historical projects database 146 may be a relational database, such as Oracle, DB2, MySQL, a NoSQL based database, such as MongoDB, or another suitable database.

In some aspects, the computing environment 100 may also include one or more personal computing devices 106. In some aspects, the personal computing devices 106 may be implemented as a network of one or more physical computing systems, a virtual private network of computing devices, a cloud computing system, a system of wearable computing devices, or any other suitable implementation. The computing device 106 may include one or more processors 130, one or more tangible, non-transitory memories, memory storage devices or data storage units 132, a user interface 136 and a communication unit 138. The processor 130 may be similar to the processor 110 (e.g., may include one or more GPUs). In an example aspect, the memory 132 may store a chatbot 134. The chatbot 134 may be analogous to the chatbot 118 and/or the NLP module 120, trained on appropriate data from a training database such as database 126.

### Exemplary Ml Model Training Methods

At a high level, the ML training module 114 performs one or more statistical analyses of training data sets. One or more training data sets for the ML model training module 114 may be obtained from an internal or an external database, such as a training database 126, the email database 140, the patent applications database 142, the historical texts database 144, the historical projects database 146, or any other suitable database. In aspects, the database 126 may store data and be used to train and/or operate one or more ML/AI models, chatbots 118, and/or voice bots. The training database 126 may be a relational database, such as Oracle, DB2, MySQL, a NoSQL based database, such as MongoDB, or another suitable database. For example, the ML training module 114 may perform regression analysis, clustering, supervised learning, semi-supervised learning, unsupervised learning, reinforcement learning, and/or other types of statistical and/or learning techniques on the training data obtained from any one of the listed databases or one or more different databases not described herein. Respective strengths of impact of attributes and/or attribute values may also be determined using the statistical analyses, and a subset of the attributes and/or attribute values having the greatest strengths of impact (either individually or in combination) may be identified to be the inputs of the chatbot 118 and/or the NLP module 120.

Broadly speaking, the ML training module 114 may train an AI or ML algorithm to, for example, scrape emails for information and perform appropriate language generative functions using the scraped information. In aspects, the ML training module 114 may train the chatbot 118 and/or the NLP module 120 to perform various functions such as scrape company emails to identify patentable ideas from company emails, and/or to determine questions associated with a scheduled meeting and generate suggested answers, and/or to determine connections between company employees, ideas, teams, or projects, and/or to assess employee satisfaction, and/or to analyze incoming emails and generate automatic responses to these emails.

Each of the chatbot 118 and/or the NLP module 120 may include one or more trained machine learning models, deep learning models, neural networks, trained artificial intelligence models, natural language processing models, and/or other suitable models, for example. In other aspects, the ML model training module 114 trains just one or both of the described exemplary ML models, or trains different ML models in addition to or instead of the described exemplary ML models. In other aspects, the chatbot 118 and the NLP module 120 each have a dedicated training module such as the ML training module 114. In other aspects, the chatbot 118 and/or the NLP module 120 may be trained on a different server or a computing system from where they are stored; the training of the models may be outsourced, or trained models may be obtained from commercial sources or open access sources, etc. Further, the one or more models may be separated by specific tasks. Separating the models in this way may advantageously enable the number of models loaded into memory, and their respective storage sizes, to be minimized, saving computational resources.

At a high level, ML training may include preparing the training data, building and training a model, and fine-tuning the model on preprocessed and feature-extracted data using transfer learning techniques. These processes involve training the ML model on a labeled dataset to adapt it to a specific task. In aspects, the ML training module 114 may perform training of ML algorithm(s) on historical data obtained from the training database 126, the email database 140, the patent applications database 142, the historical texts database 144, the historical projects database 146, or any other suitable database.

### Training Ml Model to Identify Patentable Ideas in Company Emails

In one aspect, the fine-tuned model may be optimized to maximize its accuracy in identifying patentable ideas in company emails. The ML model training method may include the following steps: (i) collecting a training dataset (ii) preprocessing the data to remove irrelevant information, (iii) extracting relevant features from the preprocessed data, (iv) selecting an appropriate ML algorithm to train the ML model, (v) training an ML model on the dataset of preprocessed and feature-extracted data, (vi) evaluating the performance of the trained ML model, and/or (vii) deploying the trained ML model to identify patentable ideas in new emails.

The training dataset may comprise a dataset of emails that have been reviewed by a patent expert, a patent agent, a patent attorney, a person with experience in the technical area or field of potential inventions, or any other qualified person, to determine which emails contain patentable ideas. The training dataset may include historical email from the company's email system or any other suitable dataset of email messages. The training dataset may be used to train the machine learning model to identify patentable ideas in company emails. The training dataset may be split into a training set and a validation set to evaluate the performance of the ML model during the training process.

The training module, such as the ML training module 114, may include a preprocessing module including various techniques to remove irrelevant information from the emails, such as email headers, signatures, and greetings. Additionally, the module may remove emails that are not related to the company's intellectual property or do not contain any patentable ideas. The training module may include a feature extraction module responsible for extracting relevant features from the preprocessed data. The features may include keywords, phrases, and concepts that are commonly associated with patentable ideas. The training module may use various techniques, such as natural language processing and text mining, to extract these features.

The ML model may be trained on the preprocessed and feature-extracted data using supervised learning techniques. Choosing an appropriate machine learning algorithm to train the ML model may involve comparing different models such as neural networks, decision trees, support vector machines, logistic regression, or any other suitable machine learning model. The model may be optimized to maximize its accuracy in identifying patentable ideas in the emails. Evaluation of the performance of the trained ML model may be performed on a separate dataset to measure the model's accuracy, precision, recall, and other performance metrics. The ML model may output a report that includes the emails that contain patentable ideas. The report may be customized to meet the needs of a user, such as highlighting relevant text in each email or providing a summary of the patentable idea(s).

In certain aspects, the ML model training may include training the model to estimate novelty of the identified patentable ideas ty comparing the identified patentable ideas to existing already patented ideas, for example published issued patents and published patent applications, or published articles, for example online scientific manuscripts, or articles published in any publicly accessible media channels, etc. As an example, the ML model may access and search an appropriate database using a Patent Query Language (PQL) or Structured Query Language (SQL). For example, to use PQL to search the USPTO patent database, the ML model may access the USPTO's Patent Full-Text and Image Database (PatFT) or the Patent Application Full-Text and Image Database (AppFT). Alternatively, the ML model may use the USPTO's Patent Application Information Retrieval (PAIR) system to search for patent applications and related documents using PQL. The ML model may search the appropriate patent database for keywords, key phrases, or patent classification codes extracted from the patentable ideas. The ML model may also compare the identified patentable ideas to any publicly accessible online content, such as product listings, advertisements, blog posts, etc.

The comparison may include generating a comparison document indicating at least one difference and/or at least one similarity between the one or more identified novel ideas and the contents of the searched data repositories. The ML model may utilize NLP to identify the similarities or differences. In aspects the ML model may estimate novelty of each of the identified patentable ideas or concepts and provide a novelty score or confidence of novelty. The novelty score or confidence may be calculated based upon similarity or difference of the identified novel idea from the analyzed published ideas. In aspects, the ML model may recommend modifications to the identified patentable ideas that would increase their novelty score.

Training Ml Model to Extract Questions Associated with Scheduled Meetings

In another aspect, the fine-tuned model may be optimized to maximize its accuracy in analyzing company emails to identify questions related to scheduled company meetings. The ML model training method may include the following steps: (i) collecting a training dataset (ii) preprocessing the data to remove irrelevant information, (iii) extracting relevant features from the preprocessed data, (iv) selecting an appropriate ML algorithm to train the ML model, (v) training an ML model on the dataset of preprocessed and feature-extracted data, (vi) evaluating the performance of the trained ML model, and/or (vii) deploying the trained ML model to identify questions related to scheduled company meetings.

The training dataset may comprise a dataset of scheduled meetings and/or a dataset of emails that have been reviewed to determine which emails contain information related to at least one scheduled meeting from the dataset of scheduled meetings. The training dataset may be split into a training set and a validation set to evaluate the performance of the ML model during the training process.

The training module such as the ML training module 114 may include a preprocessing module including various techniques to remove irrelevant information from the emails, such as email headers, signatures, and greetings. Additionally, the module may remove emails that are not related to the company's scheduled meetings. Likewise, the preprocessing module may include various techniques to remove irrelevant information from the scheduled meetings dataset, such as meeting location, meeting virtual link and/or dial-in information, information about served food, signatures, and greetings.

The training module may include a feature extraction module responsible for extracting relevant features from the preprocessed data. The features may include keywords, phrases, and concepts that are commonly associated with questions related to meeting themes or topics. The module may use various techniques, such as natural language processing and text mining, to extract these features.

In aspect, the ML model may be trained on the preprocessed and feature-extracted data using supervised learning techniques. Choosing an appropriate machine learning algorithm to train the ML model may involve comparing different models such as neural networks, decision trees, support vector machines, logistic regression, or any other suitable machine learning model. The model may be optimized to maximize its accuracy in identifying potential questions related to scheduled meetings in the emails. The trained ML model may output a report that includes the extracted questions associated with scheduled meetings, the emails that contain actual questions related to the scheduled meetings, or potential questions, or information that may be associated with a potential question, or inquiry that may be related to a potential question. The report may be customized to meet the needs of a user, such as highlighting relevant text in each email or arranging the potential questions by themes and/or topics. In aspect, the ML model may generate potential answers to the potential questions.

### Training Ml Model to Identify New Connections Between Company Employees and Projects.

In another aspect, the fine-tuned model may be optimized to maximize its accuracy in analyzing company emails to identify connections between company employees and current projects. The ML model training method may include the following steps: (i) obtaining a training dataset (ii) preprocessing the data to remove irrelevant information, (iii) extracting relevant features from the preprocessed data, (iv) selecting an appropriate ML algorithm to train the ML model, (v) training an ML model on the dataset of preprocessed and feature-extracted data, (vi) evaluating the performance of the trained ML model, and/or (vii) deploying the trained ML model to analyze company emails to identify new connections between company projects and employees. The ML model training may be performed by the ML training module 114.

The training dataset may comprise a dataset of emails that have been reviewed to determine which emails contain information related to a project or a project collaboration. The projects may be current registered company projects, client projects, or any type of individual or team projects characterized by a specific goal or objective, wherein the objective may include delivering a unique product, service, or result. The dataset is used to train the machine learning model to identify potential new collaboration in company emails. The dataset is split into a training set and a validation set to evaluate the performance of the machine learning model during the training process.

The training module may include a data preprocessing module including various techniques to remove irrelevant information from the emails, such as email headers, signatures, and greetings. Additionally, the module may remove emails that are not related to projects, project collaboration, or do not contain any information associated with company projects.

The feature extraction module may be responsible for extracting relevant features from the preprocessed data. The features may include keywords, phrases, and concepts that are commonly associated with working on a project or related to a project. The module may use various techniques, such as natural language processing and text mining, to extract these features.

The ML model may be trained on the preprocessed and feature-extracted data using supervised learning techniques. The ML model may be a neural network, decision tree, support vector machine, a logistic regression, or any other suitable machine learning model. The model may be optimized to maximize its accuracy in identifying email content and/or ideas related to a company project or projects. The output module may produce a report that includes employees who are working on similar projects or employees who are working on concepts similar or related to identified company projects but are not associated with the identified company projects. The report may be customized to meet the needs of the user, such as highlighting the relevant text in the email or providing a summary of the potential project collaboration.

In certain aspects, the ML model may generate and/or send an email or a message to an employee or employees identified as working on concepts related to company projects, introducing them to the identified projects, and/or connecting them with the identified projects, and/or suggesting ways to connect. The ML model may generate and/or send an email or a message to project manager(s), supervisor(s), lead(s), team members, coordinator(s), or secretary(ies) notifying that one or more employees were identified working on concepts or topics related to the project(s) they are working on.

### Training Ml Model to Determine Employee Satisfaction

In one aspect, the fine-tuned model may be optimized to maximize its accuracy in analyzing employee satisfaction from company emails. The ML training module, such as the module 114, may include a data preprocessing module, a feature extraction module, a machine learning model, and an output module. The ML training method may include: (i) obtaining a training dataset (ii) preprocessing the data to remove irrelevant information, (iii) extracting relevant features from the preprocessed data, (iv) selecting an appropriate ML algorithm to train the ML model, (v) training an ML model on the dataset of preprocessed and feature-extracted data, (vi) evaluating the performance of the trained ML model, and/or (vii) deploying the trained ML model to analyze emails to determine employee satisfaction.

The training dataset may include a dataset of emails that have been labeled to identify the level of employee satisfaction. The labeling may have been performed by human experts. In some aspects, the training emails may have been generated deliberately to reflect different levels of employee satisfaction. Additionally or alternatively, the labeling may be specific to employee satisfaction with, for example, the company, their specific job, a specific department, a project, a project group, a practice group, a specific initiative, a specific event, or an intervention, etc. The dataset may be used to train the ML model to identify the sentiment of employee commentary related to satisfaction in company emails, for example emails of the employee as well as emails of other employees mentioning this employee. The dataset may be split into a training set and a validation set to evaluate the performance of the ML model during the training process.

The data preprocessing module may include various techniques to remove irrelevant information from the emails, such as email headers, signatures, and greetings. Additionally, the module may remove emails that are not related to employee satisfaction or do not contain any information related to employee satisfaction.

The feature extraction module may be responsible for extracting relevant features from the preprocessed data. The features may include keywords, phrases, and concepts that are commonly associated with employee satisfaction. The module may use various techniques, such as natural language processing and text mining, to extract these features.

The trained ML model may output a report that includes names of employees and satisfaction scores. The satisfaction scores may be ranked or organized by satisfaction with various aspects of satisfaction, such as overall satisfaction with the company, satisfaction with specific project(s), etc. The report may be customized to meet the needs of a user, such as highlighting relevant text in each email. In aspects, the ML model may be trained to propose interventions to improve employee satisfaction scores.

### Training Ml Model to Generate Responses to Incoming Emails

In yet another aspect, the fine-tuned model may be optimized to analyze tone of incoming emails and generate appropriate responses. The ML training module, such as the ML training module 114, may include a data preprocessing module, a feature extraction module, a machine learning model, and an output module. The ML training method may include: (i) obtaining a training dataset (ii) preprocessing the data to remove irrelevant information, (iii) extracting relevant features from the preprocessed data, (iv) selecting an appropriate ML algorithm to train the ML model, (v) training an ML model on the dataset of preprocessed and feature-extracted data, (vi) evaluating the performance of the trained ML model, and/or (vii) deploying the trained ML model to analyze emails to determine employee satisfaction.

The training dataset may include examples of emails, texts, messages, etc. in different tones and emotions such as happy, sad, angry, surprised, dismissive, belligerent, reprimanding, flirtatious, formal, informal, etc. The training dataset may be cleaned and preprocessed before it can be used to train the ML model. The data preprocessing module may include various techniques to remove duplicate and/or irrelevant information from the emails, such as email headers, signatures, and greetings.

Feature engineering may involve extracting meaningful features from the text data that can be used to train the machine learning model. This could involve techniques such as bag-of-words, TF-IDF, or word embeddings. In aspect, the ML model may be trained on the preprocessed and feature-extracted data using supervised learning techniques. Choosing an appropriate machine learning algorithm to train the ML model may involve comparing different models such as neural networks, decision trees, support vector machines, Naive Bayes, logistic regression, or any other suitable machine learning model. The model may be optimized to maximize its accuracy in determining one or more tones of an email and generating appropriate one or more responses.

Once the ML model has been selected, it may be trained using the preprocessed dataset. The ML model may learn to identify patterns and relationships between the input (emails) and output (responses) data during the training process. After the ML model has been trained, it needs to be evaluated to see how well it performs on new, unseen data. This involves testing the ML model on a separate dataset and calculating metrics such as accuracy, precision, recall, etc. The trained machine learning model may be deployed to analyze the tone of incoming emails and generate appropriate responses. This may involve integrating the model into an email client or web application.

### Exemplary Technology

Broadly speaking, the ML training module 114 may train any AI or ML chatbot or voice bot to perform any function. Exemplary functions that the AI or ML chatbot or voice bot may be trained to perform include generating a summary document, a comparison document, a document including questions and respective answers, a document indicating thematic connections between people and projects in a company, a document including one or more generated responses to emails, and/or a request for information. Although the following discussion may refer to an ML chatbot, it should be appreciated that the following discussion applies equally to any AI or ML chatbot or voice bot of an NLP application.

Generally, the chatbot and/or voice bot may be any suitable chatbot and/or voice bot, such as a generative pre-trained transformer (GPT) chatbot. The chatbot and/or voice bot may be hosted by the server 102 or personal computing device 106. The chatbot and/or voice bot may be programmed to produce documents, simulate human conversation, interact with users, understand their needs, and recommend an appropriate line of action with minimal and/or no human intervention, among other things. This may include providing the best response of any query that it receives and/or asking follow-up questions.

In certain aspects, generative AI models (also referred to as generative ML models) may be used, and the voice bots or chatbots discussed herein may be configured to utilize AI and/or ML techniques. For instance, the voice bot or chatbot may be a ChatGPT chatbot. The voice bot or chatbot may employ supervised or unsupervised machine learning techniques, which may be followed or used in conjunction with reinforced or reinforcement learning techniques. The voice bot or chatbot may employ the techniques utilized for ChatGPT. The voice bot or chat bot may generate audio or verbal output for presentation via a speaker, and/or a visual, textual, text, or graphical output for presentation via a display. Other types of dialogue output may also be generated and presented. The outputs may be intended for consumption by human users, other computers, and/or other bots.

Noted above, in some aspects, a chatbot or other computing device may be configured to implement ML, such that server computing device “learns” to analyze, organize, and/or process data without being explicitly programmed. Machine learning may be implemented through ML methods and algorithms. In one exemplary embodiment, the ML operation module 116 may be configured to implement ML methods and algorithms.

In aspects, the ML module employs supervised learning, which involves identifying patterns in existing data to make predictions about subsequently received data. Specifically, the ML modules are “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the example embodiment, a processing element may be trained by providing it with a large sample of data with known characteristics or features.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In certain aspects, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various aspects, the implemented ML methods and algorithms are directed toward at least one of a plurality of categorizations of machine learning, such as supervised learning, unsupervised learning, and reinforcement learning.

In certain aspects, the ML chatbot may be based upon a large language model (LLM). Such an LLM may be trained to predict a word in a sequence of words. For example, the LLM may be trained to predict a next word following a given sequence of words (e.g., “next-token-prediction”), and/or trained to predict a “masked” (e.g., hidden) word within a sequence of given sequence of words (e.g., “masked-language-modeling”). For instance, in an example of next-token-prediction, the ML chatbot may be given the sequence “Jane is a”- and the ML chatbot may predict a next word, such as “dentist,” “teacher,” “mother,” etc. In an example of masked-language-modeling, the ML chatbot may receive a given sequence “Jane XYZ skiing”- and the ML chatbot may fill in XYZ with “loves,” “fears,” “enjoys,” etc.

In aspects, this prediction technique is accomplished through a long-short-term-memory (LSTM) model, which may fill in the blank with the most statistically probable word based upon surrounding context. However, the LSTM model has the following two drawbacks. First, the LSTM model does not rate/value individual surrounding words more than others. For instance, in the masked-language-modeling example of the preceding paragraph, skiing may most often be associated with “enjoys;” however Jane in particular may fear skiing but the LSTM model is not able to correctly determine this. Second, instead of being processed as a whole, the words of the input sequence are processed individually and sequentially, thus restricting the complexity of the relationships that may be inferred between words and their meanings.

Advantageously, some embodiments overcome these drawbacks of the LSTM model by using transformers (e.g., by using a generative pre-trained transformer (GPT) model). More specifically, some embodiments use a GPT model that includes (i) an encoder that processes the input sequence, and (ii) a decoder that generates the output sequence. The encoder and decoder may both include a multi-head self-attention mechanism that allows the GPT model to differentially weight parts of the input sequence to infer meaning and context. In addition, the encoder may leverage masked-language-modeling to understand relationships between words and produce improved responses.

Such multi-head self-attention mechanism may convert tokens (e.g., strings of text, such as a word, sentence, grouping of text, etc.) into vectors representing the importance of the token in the input sequence. In some embodiments, to accomplish this, the GPT model performs the following steps. First, query, key, and value vectors are created for each token in the input sequence. Second, a similarity between the query vector for the token and the key vector of every other token is calculated by taking the dot product of the two vectors. Third, normalized weights may then be generated by feeding the output of the previous step into a softmax function. Fourth, a final vector may be generated; the final vector may represent the importance of the token within the input sequence by multiplying the weights generated in the previous step by the value vectors of each token.

Furthermore, in some embodiments, rather than performing the previous four steps only once, the GPT model iterates the steps and performs them in parallel; at each iteration, new linear projection of the query, key, and value vectors are generated. Such iterative, parallel embodiments advantageously improve grasping of sub-meanings and more complex relationships within the input sequence data.

Further advantageously, some embodiments first train a basic model (e.g., a basic GPT model, etc.), and subsequently perform any of the following three steps on the basic model: supervised fine tuning (SFT); reward modeling; and/or reinforcement learning.

In the SFT step, a supervised training dataset is created. The supervised training dataset has known outputs for each input so that the model can learn from the correspondences between input and outputs. For example, to train the model to generate comparison documents, the supervised training dataset may have: (a) inputs of (i) company email communications, (ii) published patent applications, and/or (iii) auxiliary information; and (b) outputs of patentable ideas.

In another example, to train the model to generate questions associated with scheduled meetings, the supervised training dataset may have: (a) inputs of (i) company email communications, (ii) scheduled company meetings, and/or (iii) auxiliary information; and (b) outputs of (i) possible questions scraped from the email communications associated with the topics of the scheduled company meetings, and/or (ii) suggested answers to the possible questions.

In yet another example, to train the model to determine connections between company employees, ideas, teams, or projects, the supervised training dataset may have: (a) inputs of (i) company email communications, (ii) company projects associated with company employees, and/or (iii) auxiliary information; and (b) outputs of (i) possible new connections between employees and projects, and/or (ii) suggested introductions between company projects and employees.

In yet another example, to train the model to determine employee satisfaction, the supervised training dataset may have: (a) inputs of (i) company email communications, and/or (ii) auxiliary information; and (b) outputs of (i) employee satisfaction scores with company and/or projects, and/or (ii) suggested interventions to increase employee satisfaction.

In yet another example, to train the model to assess tone of incoming emails and generate possible responses, the supervised training dataset may have: (a) inputs of (i) company email communications, and/or (ii) auxiliary information; and (b) outputs of (i) one or more determined tones of the incoming email, and/or (ii) suggested one or more responses to the incoming email.

The supervised training dataset may be received (e.g., by the one or more processors 110) from any source (or combination of sources). For example, the supervised training dataset may be received from any combination of the: training database 126, email database 140, patent applications database 142, historical texts database 144, and/or historical projects database 146.

Training the basic model on the supervised training dataset may create the SFT model; and subsequent to creating the SFT model, the ML training module 114 may perform reward modeling. In reward modeling, the SFT may be fed input prompts, and may output multiple outputs (e.g., 2-10 outputs, etc.) for each input. The multiple outputs for each input may be achieved by, for example, randomness, or by controlling a predictability setting. A user (e.g., a user of the personal computing device 106, etc.) may then rank the multiple outputs for each input, thus allowing the model to associate each output with a reward (e.g., a scalar value). And the ranked outputs may then be used to further train the SFT model. For instance, the SFT model may receive an input of an email message and create seven output responses to the email message; the user may then rank the seven output email responses; and the rankings may then be fed back into the model to further train the model. Via this reward modeling step, the ML training module 114 may create a policy that the model learns. The policy may comprise a strategy for the model to maximize its reward.

Subsequently, the ML training module 114 may further train the model via reinforcement learning. Here, further inputs are fed into the model, and the model then generates, based upon the policy learned during reward modeling, (i) outputs corresponding to the inputs, and (ii) rewards values (e.g., scalar values) corresponding to the input/output pairs. The rewards values may then be fed back into the model to further evolve the policy.

In some embodiments, the reward modeling and reinforcement learning steps may be iterated through any number of times.

### Additional Considerations

The following additional considerations apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” or “some embodiments” means that a particular element, feature, structure, or characteristic described in connection with the embodiment is included in at least one embodiment. The appearances of the phrase “in one embodiment” or “in some embodiments” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computer system for analyzing emails to determine patentable concepts, the computer system comprising one or more processors configured to:
access one or more email messages;
identify, via a machine learning (ML) chatbot trained to analyze text and generate text, one or more patentable concepts in the one or more email messages;
compare the one or more patentable concepts to a patent database including published patent applications with respective publication dates on or before the date of database access, wherein comparing includes generating a comparison document indicating at least one difference and/or at least one similarity between the one or more patentable concepts and the patent applications of the patent database, wherein the comparing includes using the ML chatbot; and
generate, based upon the comparison, one or more novelty scores for each of the one or more patentable concepts.

2. The computer system of claim 1, further comprising training, via the one or more processors, the ML chatbot based upon historical data comprising: (i) independent variables comprising historical email messages, and/or (ii) dependent variables comprising historical patentable concepts.

3. The computer system of claim 2, wherein the one or more processors are further configured to identify, via the ML chatbot, one or more patentable concepts associated with a predefined topic or a predefined technical area.

4. The computer system of claim 2, wherein the one or more processors are further configured to:
access the one or more email messages at predetermined time intervals; and
alert a user with identified one or more patentable concepts when one or more novelty scores exceed a predefined threshold.

5. The computer system of claim 2, wherein the one or more processors are further configured to:
interview, via the ML chatbot or a voice bot, a user; and
analyze, via the ML chatbot or a voice bot, an interview transcript to determine one or more patentable concepts from the interview.

6. The computer system of claim 2, wherein the patent database includes one or more public access patent databases and/or one or more internal intellectual property databases.

7. The computer system of claim 1, wherein the one or more processors are further configured to, via the ML chatbot:
identify, from the accessed one or more email messages, one or more potential questions associated with a scheduled meeting;
identify percentage of the scheduled meeting attendees associated with the each one or more potential questions;
determine probability of the each one or more potential questions being asked;
generate suggested answers to the each one or more potential questions; and
send the list of identified one or more potential questions and their suggested answers to a meeting organizer.

8. The computer system of claim 7, further comprising training, via the one or more processors, the ML chatbot based upon historical data comprising: (i) independent variables comprising historical questions, and/or (ii) dependent variables comprising historical answers.

9. The computer system of claim 7, wherein the one or more processors are further configured to, via the ML chatbot, determine, from the accessed one or more email messages, if there are discrepancies in viewpoints on a particular topic; and generate a report summarizing the discrepancies in viewpoints.

10. The computer system of claim 1, wherein the one or more processors are further configured to:
receive, at the ML chatbot, a list of employees associated with one or more projects;
analyze, via the ML chatbot, the accessed one or more email messages, and label email messages associated with the one or more projects;
identify, via the ML chatbot, email message authors of the labeled email messages;
identify, via the ML chatbot, select labeled email messages, associated with projects which authors are not associated with the one or more projects; and
generate, via the ML chatbot, an email message to the select labeled email messages authors, inviting the select labeled email messages authors to connect with the employees associated with the one or more projects.

11. The computer system of claim 10, further comprising training, via the one or more processors, the ML chatbot based upon historical data comprising: (i) independent variables comprising historical email messages, and/or (ii) independent variables comprising descriptions of different projects, and/or (iii) dependent variables comprising associations between historical email messages and descriptions of different projects.

12. The computer system of claim 1, wherein the one or more processors are further configured to:
analyze, via the ML chatbot, the accessed one or more email messages to determine an employee satisfaction score.

13. The computer system of claim 12, further comprising training, via the one or more processors, the ML chatbot based upon historical data comprising: (i) independent variables comprising historical texts, and/or (ii) dependent variables comprising satisfaction rating associated with the authors and/or topics of the respective historical texts.

14. The computer system of claim 13, wherein the satisfaction score is associated with at least a particular project, a particular team, or with a workplace.

15. The computer system of claim 13, wherein the one or more email messages includes video data, and the ML chatbot extracts and analyzes employee facial expression from the video data.

16. The computer system of claim 1, wherein the one or more processors are further configured to:
analyze, via the ML chatbot, contents of a received email message from the accessed one or more email messages;
determine, via the ML chatbot, a tone of the analyzed received email message; and
generate, via the ML chatbot, one or more responses to the analyzed received email message, at least one of the responses using the determined tone of the analyzed received email message.

17. The computer system of claim 16, further comprising training, via the one or more processors, the ML chatbot based upon historical data comprising: (i) independent variables comprising historical texts, and/or (ii) dependent variables comprising tone of the historical texts.

18. A computer-implemented method for analyzing emails to determine patentable concepts, the method comprising, via one or more processors:
accessing one or more email messages;
identifying, with a machine learning (ML) chatbot trained to analyze text and generate text, one or more patentable concepts in the one or more email messages;
comparing the one or more patentable concepts to a patent database including published patent applications with respective publication dates on or before the date of database access, wherein the comparing includes generating a comparison document indicating at least one difference and/or at least one similarity between the one or more patentable concepts and the patent applications of the patent database, and wherein the comparing includes using the ML chatbot; and
generating, based upon the comparison, one or more novelty scores for each of the one or more patentable concepts.

19. The computer-implemented method of claim 18, further comprising training the ML chatbot based upon historical data comprising: (i) independent variables comprising historical email messages, and/or (ii) dependent variables comprising historical patentable concepts.

20. The computer-implemented method of claim 19, further comprising identifying, via the ML chatbot, one or more patentable concepts associated with a predefined topic or a predefined technical area.
